(19) United States
(12) Patent Application Publication
(10) Pub. No.: US 2020/0361035 A1
(43) Pub. Date: Nov. 19, 2020

(54) METHOD FOR PRODUCING A COMPONENT BY MEANS OF AN ADDITIVE MANUFACTURING METHOD USING A LASER

(71) Applicant: Universität Stuttgart, Stuttgart (DE)

(72) Inventors: Moritz Käss, Stuttgart (DE); Martin Werz, Stuttgart (DE); Stefan Weihe, Buxheim (DE)

(73) Assignee: Universitãt Stuttgart, Stuttgart (DE)

(21) Appl. No.: 15/929,681

(22) Filed: May 15, 2020

(30) Foreign Application Priority Data
May 16, 2019 (DE) 10 2019 207 111.2

(51) Int. Cl. B23K 26/342; B23K 26/06; B23K 26/08; B23K 26/12; B23K 35/30; B23K 35/28; B33Y 10/00; B33Y 40/00; B33Y 70/00; C22C 38/40

(52) U.S. Cl. CPC B23K 26/342; B23K 26/0626; B23K 26/0665; B23K 26/08; B23K 26/125; B23K 2103/10; B23K 35/286; B33Y 10/00; B33Y 40/00; B33Y 70/00; C22C 38/40; B23K 35/3066

(57) ABSTRACT

A method for producing a component by means of an additive manufacturing method using a laser is proposed, the method comprising the following steps:
(a) providing a metal powder,
(b) applying a powder layer (18) of the metal powder to a build platform (14) of a process chamber (12),
(c) introducing a first process gas into the process chamber (12),
(d) melting a first selected region (36) of the applied powder layer (18) by means of a laser in a first atmosphere which includes the first process gas,
(e) introducing a second process gas into the process chamber (12), wherein the second process gas differs from the first process gas at least in terms of its composition and/or its pressure, and
(f) melting a second selected region (38) of the applied powder layer (18) by means of the laser in a second atmosphere which includes the second process gas, wherein the second selected region (38) differs from the first selected region (36).

### CROSS-REFERENCE TO RELATED APPLICATION

This application claims the benefit of German Application No. 10 2019 207 111.2, filed May 16, 2019, the entire disclosure of which is hereby incorporated by reference.

### DESCRIPTION

Additive manufacturing designates a process in which a component is built up layer-by-layer by means of the deposition of material on the basis of digital 3D construction data. Additive manufacturing is a professional production process which differs markedly from conventional material-removing manufacturing methods. Instead of for example milling a workpiece out of a solid block, additive manufacturing builds up components in layers from materials in the form for example of a fine powder.

Additive manufacturing methods in particular include selective laser sintering and selective laser melting. In these methods, a build area is successively coated with a particular metal powder which is melted using a laser. By way of layer-by-layer melting and subsequent solidification of the metal powder by cooling, a component is formed by placing a plurality of individual layers on top of one another and bonding them. In this way, complex structures and three-dimensional geometries can be realized, it being possible to produce these in a single work step without the use of a tool.

Despite the numerous advantages of the powder bed-based additive manufacturing methods known from the prior art, these still have potential for improvement. In powder bed-based additive manufacturing processes, the local modification of the microstructure formation by means of various chemical compositions of the pulverulent starting material is possible nowadays only with considerable technical outlay in powder management, if at all. However, certain desired material properties can only be achieved in additively manufactured components when a selectively adjustable alloy composition is possible. In conventional powder bed-based additive processes, it is always the case that an entire layer of the same powder is applied using a doctor blade. In this case, a material change or a material gradation is not possible within a layer and is possible over the height of the component only via very complex powder management with a plurality of powder stores.

### DISCLOSURE OF THE INVENTION

A method is therefore proposed which at least to a large extent avoids the disadvantages of known methods. In particular, a method for producing a component by means of an additive manufacturing method using a laser is proposed in which locally different alloy compositions are realizable and result in the formation of differing microstructures.

A method according to the invention for producing a component by means of an additive manufacturing method using a laser comprises the following steps, preferably in the sequence specified:

(a) providing a metal powder,

(b) applying a powder layer of the metal powder to a build platform of a process chamber,

(c) introducing a first process gas into the process chamber,

(d) melting a first selected region of the applied powder layer by means of a laser in a first atmosphere which includes the first process gas,

(e) introducing a second process gas into the process chamber, wherein the second process gas differs from the first process gas at least in terms of its composition and/or its pressure, and

(f) melting a second selected region of the applied powder layer by means of the laser in a second atmosphere which includes the second process gas, wherein the second selected region differs from the first selected region.

The method makes it possible to use the process gas or protective gas, already employed as standard, for the modification of the alloy composition. In this case, a locally varying mixing of protective gases with the metal melt has to be achieved. This may be achieved, firstly, by using different protective gases within a build job, and also by modifying process parameters such as build chamber pressure, laser power or by laser oscillation.

A plurality of layers are applied in succession to the build platform in the method. The method accordingly comprises repeating, in particular repeating multiple times, at least steps (a) to (d) and/or repeating, in particular repeating multiple times, steps (e) and (f). In this case, the process sequence is such that a first layer is applied to the build platform. Subsequently, predetermined regions of the first layer are melted by means of laser. However, by varying the parameters of the process gases, the alloy composition can be locally modified such that locally varying microstructures are formed. In this case, a portion of the metal powder on the build platform is melted and solidified by cooling. This solidified region constitutes part of the form of the component to be produced. Following this, the build platform is lowered slightly and a second layer is applied. Predetermined regions of the second layer are subsequently melted by means of laser in the manner described above. In this case, a portion of the metal powder on the build platform is once again melted and solidified by cooling. This region constitutes a further portion of the form of the component.

The melting in step (d) is conducted in such a way that the first selected region during subsequent cooling becomes permanently bonded to the underlying material. Alternatively or additionally, the melting in step (f) can be conducted in such a way that the second selected region during subsequent cooling becomes permanently bonded to the underlying material. The respective bond is in this case formed with the build platform or with the layer located directly underneath. Accordingly, a bond is formed which can only be detached by destruction.

The metal powder may be a metal alloy. For example, the metal powder is an aluminium alloy.

In one embodiment, the metal powder is composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti.

The first process gas and/or the second process gas can include at least one gas selected from the group consisting of: argon, helium, nitrogen, carbon monoxide, carbon dioxide, methane, propane, hydrogen and oxygen. Within the context of the present invention, the fact that that some process gases simultaneously constitute alloying elements or, as in the case of carbon, can take up or release these, thus acquired particular significance. For example, argon and helium are both inert. Nitrogen acts as an austenite former in the case of steels. Carbon monoxide, carbon dioxide, methane and propane each bring about carburization. Hydrogen ensures pore formation, if required. Oxygen brings about a reduction in carbon.

The first process gas and the second process gas can include hydrogen, wherein the concentration of hydrogen in the first process gas is higher than the concentration of hydrogen in the second process gas. Therefore, more pores can form in the first selected region than in the second region. Using hydrogen-containing atmosphere, especially in the case of aluminium, can generate a porosity in the material in a controlled manner depending on the hydrogen content. This is based on the fact that the solubility of hydrogen in aluminium in the liquid state is markedly higher than in the solid state. On solidification, the no longer soluble hydrogen is expelled in the form of small pores. Depending on the original partial pressure of hydrogen in the process gas atmosphere, or dissolved in the aluminium melt, large or small pores, or even no pores, are formed.

During the melting in step (d) and/or in step (f), the pressure in the process chamber can be varied. Varying the pressure in the process gas-flooded process chamber can influence the gas absorption of the melt. In particular, an overpressure of nitrogen oxide (N₂) can increase its solubility and absorbability in the melt pool. In general, pressures from a vacuum up to in particular 10 bar are expedient. In this way, influence can be exerted on the alloy composition and hence on the resulting microstructure solely by way of the pressure variation.

The method can furthermore comprise at least partially heat treating the applied layer during the melting in step (d) and/or in step (f). The transformation of the microstructures in steels is generally temperature-dependent. The cooling conditions can also influence the microstructure that arises. By way of example, abrupt cooling is used during hardening in order to obtain a martensitic microstructure instead of a ferritic microstructure. By modifying the cooling conditions or the temperature within the process chamber during an additive manufacturing process, it is therefore also possible to influence phase transformations or to trigger these phase transformations at particular times in the manufacturing process.

Alternatively or additionally, the method can furthermore comprise at least partially heat treating the applied layer after the melting in step (d) and/or in step (f). A subsequent heat treatment can also be used to achieve certain properties through modification of the microstructure. Normalization, solution annealing and quenching or hardening are conceivable, for example. Depending on the cooling rate, thermal gradients or different transients in the component arise during this heat treatment process. In these subsequent heat treatments it is in particular also possible to achieve hardening of different regions to different degrees by means of selective carburization during the additive manufacturing process. A variation in the strength can thus be realized by the different carbon content in the hardened microstructure. In order to set a certain internal stress state of a component in which different alloy compositions have been realized at different locations during the production, different effects can be used in a heat treatment downstream of the melting, such as for example heating, holding and cooling. These are the influencing of the temperature at which a phase transformation starts or is completed, the influencing of the strength that the material has at a particular temperature, in interplay with stresses that result from thermal gradients, and the influencing of the level of strains arising during the phase transformation, for example in the transformation from austenite to martensite or from austenite to ferrite. In order to be able to employ the effects deliberately and in a quantitatively expedient manner, it is of course possible to use analytical, numerical and experimental methods for the, optionally iterative, achievement of a desired state.

The heat treatment can comprise annealing, stress relief annealing, diffusion annealing or low hydrogen annealing.

The heat treatment can be effected by means of a defocused laser. For the modification of the cooling conditions or the temperature within the process chamber, a second, defocused laser beam can for example be used with which entire layers or relatively large regions within layers can be pre- or post-heated.

The first process gas and/or the second process gas can be introduced into the process chamber in such a way that a laminar gas flow above the applied powder layer is generated. This enables a change of the process gas to be carried out as quickly as possible. The speed of the change can be increased by the use of protective gas nozzles which generate a laminar protective gas flow in very close proximity above the component.

The method can furthermore comprise arranging a glass plate at a predetermined distance from the applied powder layer, the predetermined distance being in a range from 0.5 mm to 20.0 cm and preferably from 1.0 cm to 10.0 cm. Such an arrangement of a glass plate delimits the process gas flow/the process gas volume between the powder surface and laser optical unit in the direction of the laser. The distance stated has proven to be a preferred distance in this case.

The laser can oscillate during the melting in step (d) and/or in step (f). Oscillation of the laser beam makes it possible to achieve improved dynamics in the melt pool, which can be utilized for better mixing of the metal melt with the process gas. In this way, influencing of the alloy composition can be achieved even with a relatively low partial pressure of the process gas. It is moreover possible by way of a selective oscillation of the laser to control the mixing with the process gas and in this way to obtain locally varying alloy compositions within a layer under otherwise unchanged process conditions.

The melting in step (f) can be carried out in such a way that the region melted in step (d) is at least partially melted again. Alternatively or additionally, the melting in step (f) can be carried out in such a way that the second selected region is at least partially melted again. It is possible to melt specific regions within a layer once in order to enrich the melt with a particular gas concentration. By way of a change of protective gas, the concentration of the alloying elements in the melt can now be further modified in a second or renewed melting. In addition, the renewed local introduction of heat can in this way modify the internal stress state.

A power and/or a focus of the laser can be varied during the melting in step (d) and/or in step (f). Both “deep welding processes” with pronounced vapour capillaries and heat conduction welding processes are used in additive manufacturing. In general, the method presented here is applicable in both forms. In principle, however, there is considerably more intense mixing of the melt with deep welding than with heat conduction welding. Accordingly, the process mode has an effect on the efficacy of the chemical influencing by the process gas (high or low introduction of the gas). The change of the process mode can in particular be employed in a selective manner by variation of the laser power and possibly variation of the focal position (defocusing) in order to influence the chemical composition, microstructure and also the introduction of heat.

The method can furthermore comprise applying or introducing at least one alloying element into the applied powder layer in the first selected region and/or in the second selected region. The alloying element can in particular be applied or introduced in the form of a suspension. Using process gases it is only possible to introduce alloying elements which can be handled as a gas. However, with customary process gases only the carbon and nitrogen content can be influenced. Both elements influence the microstructure formation on account of their property as nickel equivalent. In order to also be able to utilize the effects of other equivalents, in particular chromium equivalents, it is additionally possible to introduce alloying elements in the form of a suspension having very fine particles, i.e. substantially smaller than the powder particles. To this end, for example, Si or Ti can be selectively introduced into individual layers or into parts of layers. Ethanol is particularly suitable here as solvent. Drying-off of the ethanol prior to the melting can be achieved by a defocused laser beam or an appropriate preheating system of the build chamber. This selective application of a suspension can also locally influence the alloy composition. Compared to the application of a completely different powder by the doctor blade, the use of a suspension can be realized with substantially less expense. This is based on the fact that, with an application apparatus for applying the metal powder, up to 100% of the powder of a layer can be applied very cost-effectively and simply. Only a few percent of an additional alloying element, in particular of an element acting as chromium equivalent, are additionally applied.

The alloying element can be applied or introduced by means of a printhead. In this context, a printhead is understood to mean an at least two-dimensional element of individual nozzles or outlet openings via which a powder, a suspension or a powder-laden gas stream can be dispensed in a finely metered manner. The printhead can comprise the entire breadth of the powder bed. Alternatively, a plurality of printheads may be connected in series or the printhead may be displaced by approximately its length each time. The printhead is displaced transversely to the nozzle arrangement in order to traverse the build chamber. The spatial resolution of the printhead preferably corresponds to approximately that of the laser scanner or approximately to the hatch spacing of the scan. For example, Si or Ti can be selectively introduced into individual layers or into parts of layers by a printhead. Ethanol is particularly suitable here as solvent. Drying-off of the ethanol prior to the melting can be achieved by a defocused laser beam or an appropriate preheating system of the build chamber. This selective application of a suspension can also locally influence the alloy composition. Compared to the application of a completely different powder by the doctor blade, the use of a suspension can be realized with substantially less expense.

The powder layer can be applied by means of an application apparatus, in particular a doctor blade, to the build platform, with the application apparatus and the printhead being moved by a common actuator. The doctor blade and the printhead can therefore constitute a unit and in this case can be moved via a common actuator or else be moved via two mutually independent actuators. This makes it possible in particular for the speed of the doctor blade application of powder and the speed of the “printing” of the suspension to be independently chosen.

The melting in step (d) can be carried out in such a way that the first selected region after a subsequent cooling has a first metallurgical structure, wherein the melting in step (f) can be carried out in such a way that the second selected region after a subsequent cooling has a second metallurgical structure, and wherein the second metallurgical structure differs from the first metallurgical structure.

An apparatus according to the invention for producing a component by means of an additive manufacturing method using a laser comprises:

a process chamber having a build platform,

an application apparatus, in particular a doctor blade, for applying a powder layer of a metal powder to the build platform,

a process gas nozzle for introducing process gas into the process chamber,

at least one laser source for emitting a laser onto the powder layer and

a valve assembly for the selective supply of process gas to the process gas nozzle, wherein the valve assembly has at least a first valve path and a second valve path, wherein the valve assembly is connectible to a first process gas source and to a second process gas source, wherein the first valve path and the second valve path are actuable separately from one another in such a way that a first process gas from the first process gas source and/or a second process gas from the second process gas source are selectively introducible into the process chamber by means of the process gas nozzle.

The apparatus can furthermore comprise a control apparatus for automatically controlling the valve assembly on the basis of numerical data which define the geometric form of the component to be produced.

The apparatus can furthermore comprise a printhead for applying or introducing an alloying element, especially in the form of a suspension, onto or into the powder layer on the build platform.

The apparatus can furthermore comprise an actuator, the actuator being designed for jointly moving the application apparatus and the printhead.

The process gases can differ in terms of their composition.

Furthermore, the use of an apparatus in accordance with the description above for carrying out a method in accordance with the description above is disclosed.

A method for producing a component by means of an additive manufacturing method using a laser is furthermore proposed, the method comprising the following steps, preferably in the sequence specified:

providing a metal powder,

applying a powder layer of the metal powder to a build platform of a process chamber,

applying or introducing at least one alloying element, especially in the form of a suspension, onto or into the applied powder layer in at least one selected region, and

melting the applied powder layer by means of a laser.

As an alternative to the gaseous introduction of alloying elements, alloying elements can thus be applied in the form of a suspension. Using process gases it is only possible to introduce alloying elements which can be handled as a gas. However, with customary process gases only the carbon and nitrogen content can be influenced. Both elements influence the microstructure formation on account of their property as nickel equivalent. In order to also be able to utilize the effects of chromium equivalents, it is additionally possible to introduce alloying elements in the form of a suspension having very fine particles, i.e. substantially smaller than the powder particles.

The alloying element can be applied or introduced by means of a printhead. To this end, for example, Si or Ti can be selectively introduced into individual layers or into parts of layers by a printhead fitted to the doctor blade. Ethanol is particularly suitable here as solvent. Drying-off of the ethanol prior to the melting can be achieved by a defocused laser beam or an appropriate preheating system of the build chamber. This selective application of a suspension can also locally influence the alloy composition. Compared to the application of a completely different powder by the doctor blade, the use of a suspension can be realized with substantially less expense. This is based on the fact that, with the doctor blade, up to 100% of the powder of a layer can be applied very cost-effectively and simply. Only a few percent of an additional alloying element, in particular of an element acting as chromium equivalent

are applied with a printhead. In this context, a printhead is understood to mean an at least two-dimensional element of individual nozzles or outlet openings via which a powder, a suspension or a powder-laden gas stream can be dispensed in a finely metered manner. The printhead can comprise the entire breadth of the powder bed. Alternatively, a plurality of printheads may be connected in series or the printhead may be displaced by approximately its length each time. The printhead is displaced transversely to the nozzle arrangement in order to traverse the build chamber. The spatial resolution of the printhead preferably corresponds to approximately that of the laser scanner or approximately to the hatch spacing of the scan.

The powder layer can be applied by means of an application apparatus, in particular a doctor blade, to the build platform, with the application apparatus and the printhead being moved by a common actuator. The doctor blade and the printhead can constitute a unit and in this case can be moved via a common actuator or else be moved via two mutually independent actuators. This makes it possible in particular for the speed of the doctor blade application of powder and the speed of the “printing” of the suspension to be independently chosen.

The method can furthermore comprise the following steps:

introducing a first process gas into the process chamber,

melting a first selected region of the applied powder layer by means of a laser in a first atmosphere which includes the first process gas,

introducing a second process gas into the process chamber, wherein the second process gas differs from the first process gas at least in terms of its composition and/or its pressure, and

melting a second selected region of the applied powder layer by means of the laser in a second atmosphere which includes the second process gas, wherein the second selected region differs from the first selected region.

The method makes it possible to use the process gas or protective gas, already employed as standard, for the modification of the alloy composition. In this case, a locally varying mixing of protective gases with the metal melt has to be achieved. This may be achieved, firstly, by using different protective gases within a build job, and also by modifying process parameters such as build chamber pressure, laser power or by laser oscillation.

The melting can be carried out in such a way that the first and/or second selected region during subsequent cooling becomes permanently bonded. The respective bond is in this case formed with the build platform or with the layer located directly underneath. Accordingly, a bond is formed which can only be detached by destruction.

The metal powder may be a metal alloy. For example, the metal powder is an aluminium alloy.

In one embodiment, the metal powder is composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti.

The first process gas and/or the second process gas can include at least one gas selected from the group consisting of: argon, helium, nitrogen, carbon monoxide, carbon dioxide, methane, propane, hydrogen and oxygen. Within the context of the present invention, the fact that that some process gases simultaneously constitute alloying elements or, as in the case of carbon, can take up or release these, thus acquired particular significance. For example, argon and helium are both inert. Nitrogen acts as an austenite former in the case of steels. Carbon monoxide, carbon dioxide, methane and propane each bring about carburization. Hydrogen ensures pore formation, if required. Oxygen brings about a reduction in carbon.

The first process gas and the second process gas can include hydrogen, wherein the concentration of hydrogen in the first process gas is higher than the concentration of hydrogen in the second process gas. Therefore, more pores can form in the first selected region than in the second region. Using hydrogen-containing atmosphere, especially in the case of aluminium, can generate a porosity in the material in a controlled manner depending on the hydrogen content. This is based on the fact that the solubility of hydrogen in aluminium in the liquid state is markedly higher than in the solid state. On solidification, the no longer soluble hydrogen is expelled in the form of small pores. Depending on the original partial pressure of hydrogen in the process gas atmosphere, or dissolved in the aluminium melt, large or small pores, or even no pores, are formed.

During the melting, the pressure in the process chamber can be varied. Varying the pressure in the process gas-flooded process chamber can influence the gas absorption of the melt. In particular, an overpressure of nitrogen oxide (N₂) can increase its solubility and absorbability in the melt pool. In general, pressures from a vacuum up to in particular 10 bar are expedient. In this way, influence can be exerted on the alloy composition and hence on the resulting microstructure solely by way of the pressure variation.

The method can furthermore comprise at least partially heat treating the applied layer during the melting. The transformation of the microstructures in steels is generally temperature-dependent. The cooling conditions can also influence the microstructure that arises. By way of example, abrupt cooling is used during hardening in order to obtain a martensitic microstructure instead of a ferritic microstructure. By modifying the cooling conditions or the temperature within the process chamber during an additive manufacturing process, it is therefore also possible to influence phase transformations or to trigger these phase transformations at particular times in the manufacturing process.

Alternatively or additionally, the method can furthermore comprise at least partially heat treating the applied layer after the melting.

The heat treatment can comprise melting, sintering, annealing, diffusion treatment or hydrogen-reducing treatment. A subsequent heat treatment can also be used to achieve certain properties through modification of the microstructure. Normalization, solution annealing and quenching or hardening are conceivable, for example. Depending on the cooling rate, thermal gradients or different transients in the component arise during this heat treatment process. In these subsequent heat treatments it is in particular possible to achieve hardening of different regions to different degrees by means of selective carburization during the additive manufacturing process. A variation in the strength can thus be realized by the different carbon content in the hardened microstructure. In order to set a certain internal stress state of a component in which different alloy compositions have been realized at different locations during the production, different effects can be used in a heat treatment downstream of the melting, such as for example heating, holding and cooling. These are the influencing of the temperature at which a phase transformation starts or is completed, the influencing of the strength that the material has at a particular temperature, in interplay with stresses that result from thermal gradients, and the influencing of the level of strains arising during the phase transformation, for example in the transformation from austenite to martensite or from austenite to ferrite. In order to be able to employ the effects deliberately and in a quantitatively expedient manner, it is of course possible to use analytical, numerical and experimental methods for the, optionally iterative, achievement of a desired state.

The heat treatment can be effected by means of a defocused laser. For the modification of the cooling conditions or the temperature within the process chamber, a second, defocused laser beam can for example be used with which entire layers or relatively large regions within layers can be pre- or post-heated.

The first process gas and/or the second process gas can be introduced into the process chamber in such a way that a laminar gas flow above the applied powder layer is generated. This enables a change of the process gas to be carried out as quickly as possible. The speed of the change can be increased by the use of protective gas nozzles which generate a laminar protective gas flow in very close proximity above the component.

The method can furthermore comprise arranging a glass plate at a predetermined distance from the applied powder layer, the predetermined distance being in a range from 0.5 mm to 20.0 cm and preferably from 1.0 cm to 10.0 cm. Such an arrangement of a glass plate delimits the process gas flow/the process gas volume between the powder surface and laser optical unit in the direction of the laser. The distance stated has proven to be a preferred distance in this case.

The laser can oscillate during the thermal treatment. Oscillation of the laser beam makes it possible to achieve improved dynamics in the melt pool, which can be utilized for better mixing of the metal melt with the process gas. In this way, influencing of the alloy composition can be achieved even with a relatively low partial pressure of the process gas. It is moreover possible by way of a selective oscillation of the laser to control the mixing with the process gas and in this way to obtain locally varying alloy compositions within a layer under otherwise unchanged process conditions.

The melting can be carried out in such a way that the first selected region is at least partially melted again. Alternatively or additionally, the melting can be carried out in such a way that the second selected region is at least partially melted again. It is possible to melt specific regions within a layer once in order to enrich the melt with a particular gas concentration. By way of a change of protective gas, the concentration of the alloying elements in the melt can now be further modified in a second or renewed melting. In addition, the renewed local introduction of heat can in this way modify the internal stress state.

A power and/or a focus of the laser can be varied during the melting in step. Both “deep welding processes” with pronounced vapour capillaries and heat conduction welding processes are used in additive manufacturing. In general, the method presented here is applicable in both forms. In principle, however, there is considerably more intense mixing of the melt with deep welding than with heat conduction welding. Accordingly, the process mode has an effect on the efficacy of the chemical influencing by the process gas (high or low introduction of the gas). The change of the process mode can in particular be employed in a selective manner by variation of the laser power and possibly variation of the focal position (defocusing) in order to influence the chemical composition, microstructure and also the introduction of heat.

The melting can be carried out in such a way that the first selected region after a subsequent cooling has a first metallurgical structure, and the melting can be carried out in such a way that the second selected region after a subsequent cooling has a second metallurgical structure, wherein the second metallurgical structure differs from the first metallurgical structure.

Individual method steps or all method steps can be repeated, in particular repeated multiple times.

Furthermore, an apparatus for producing a component by means of an additive manufacturing method using a laser is disclosed, the apparatus comprising:

a process chamber having a build platform,

an application apparatus, in particular a doctor blade, for applying a powder layer of a metal powder to the build platform, and

a printhead for applying or introducing an alloying element, especially in the form of a suspension, onto or into the powder layer on the build platform at least one laser source for emitting a laser onto the powder layer.

The apparatus can furthermore comprise an actuator, the actuator being designed for jointly moving the application apparatus and the printhead.

The apparatus can furthermore comprise a process gas nozzle for introducing process gas into the process chamber

The apparatus can furthermore comprise a valve assembly for the selective supply of process gas to the process gas nozzle, wherein the valve assembly has at least a first valve path and a second valve path, wherein the valve assembly is connectible to a first process gas source and to a second process gas source, wherein the first valve path and the second valve path are actuable separately from one another in such a way that a first process gas from the first process gas source and/or a second process gas from the second process gas source are selectively introducible into the process chamber by means of the process gas nozzle.

The apparatus can furthermore comprise a control apparatus for automatically controlling the valve assembly on the basis of numerical data which define the geometric form of the component to be produced.

It is explicitly emphasized that, in the method according to the explanations above and also according to the explanations following hereinbelow, a change can be effected between the first process gas and the second process gas by moving a sealing slide within the process chamber relative to the build platform or the powder layer located thereupon. The sealing slide can in this case in particular be moved in a relative manner parallel to the build platform.

Accordingly, the apparatus according to the explanations above and also according to the explanations following hereinbelow may have within the process chamber a sealing slide which is movable relative to the build platform. The sealing slide may in this case in particular be movable in a relative manner parallel to the build platform.

The sealing slide can be connected to the application apparatus, such as for example to the doctor blade, for example by means of a frame. The application apparatus may be movable relative to the build platform. As a result, the sealing slide is movable together with the application apparatus.

Unless otherwise indicated, all percentages mentioned within the context of this disclosure relate to weight percent.

A fundamental idea of the present invention is that, during the entire process, a powder having the same composition, in particular alloy composition, can be used. However, by means of the process gas or protective gas or by means of application of a suspension, the alloy composition can be locally modified such that locally varying microstructures are formed. In the context of the present invention, it is now proposed to use these process gases for the selective introduction of alloying elements, in order to influence the chemical composition of the material during the formation of the melt pool. In this case, even small proportions of additional alloying elements can suffice to significantly modify the developing microstructure, the phase transformation (nature, time, temperature and microstructure proportions) and the resulting internal stress state.

The capability of forming locally varying microstructures opens up a multitude of possibilities for producing components having specific properties. For example, the ferritic core of a component can serve for achieving a high strength especially in the event of static mechanical loading. If a resistance to the influence of media is required, this can be done by establishing an austenitic microstructure at the surface. As protection against abrasion or for the achievement of internal compressive stresses in the surface, formation of the hardened microstructure martensite may be desirable. Internal compressive stresses represent a possibility for improving the fatigue strength for components under cyclical loading.

In summary, the present disclosure encompasses the following embodiments.:

Embodiment 1: Method for producing a component by means of an additive manufacturing method using a laser, the method comprising the following steps:

(a) providing a metal powder,

(b) applying a powder layer of the metal powder to a build platform of a process chamber,

(c) introducing a first process gas into the process chamber,

(d) melting a first selected region of the applied powder layer by means of a laser in a first atmosphere which includes the first process gas,

(e) introducing a second process gas into the process chamber, wherein the second process gas differs from the first process gas at least in terms of its composition and/or its pressure, and

(f) melting a second selected region of the applied powder layer by means of the laser in a second atmosphere which includes the second process gas, wherein the second selected region differs from the first selected region.

Embodiment 2: Method according to embodiment 1, furthermore comprising repeating, in particular repeating multiple times, at least steps (a) to (d).

Embodiment 3: Method according to embodiment 1 or 2, furthermore comprising repeating, in particular repeating multiple times, steps (e) and (f).

Embodiment 4: Method according to any of embodiments 1 to 3, furthermore comprising melting in step (d) in such a way that the first selected region during subsequent cooling becomes permanently bonded, and/or melting in step (f) in such a way that the second selected region during subsequent cooling becomes permanently bonded.

Embodiment 5: Method according to any of embodiments 1 to 4, wherein the metal powder is a metal alloy, in particular aluminium alloy.

Embodiment 6: Method according to any of embodiments 1 to 4, wherein the metal powder is composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti.

Embodiment 7: Method according to any of embodiments 1 to 6, wherein the first process gas and/or the second process gas include(s) at least one gas selected from the group consisting of: argon, helium, nitrogen, carbon monoxide, carbon dioxide, methane, propane, hydrogen and oxygen.

Embodiment 8: Method according to any of embodiments 1 to 7, wherein the first process gas and the second process gas include hydrogen, wherein the concentration of hydrogen in the first process gas is higher than the concentration of hydrogen in the second process gas.

Embodiment 9: Method according to any of embodiments 1 to 8, wherein during the melting in step (d) and/or in step (f) a pressure in the process chamber is varied.

Embodiment 10: Method according to any of embodiments 1 to 9, furthermore comprising at least partially heat treating the applied layer during the melting in step (d) and/or in step (f).

Embodiment 11: Method according to any of embodiments 1 to 10, furthermore comprising at least partially heat treating the applied layer after the melting in step (d) and/or in step (f).

Embodiment 12: Method according to embodiment 10 or 11, wherein the heat treatment comprises melting, sintering, annealing, stress relief annealing, diffusion annealing or low hydrogen annealing.

Embodiment 13: Method according to any of embodiments 10 to 12, wherein the heat treatment is effected by means of a defocused laser.

Embodiment 14: Method according to any of embodiments 1 to 13, wherein the first process gas and/or the second process gas is/are introduced into the process chamber in such a way that a laminar gas flow above the applied powder layer is generated.

Embodiment 15: Method according to embodiment 14, furthermore comprising arranging a glass plate at a predetermined distance from the applied powder layer, the predetermined distance being in a range from 0.5 mm to 20.0 cm and preferably from 1.0 cm to 10.0 cm.

Embodiment 16: Method according to any of embodiments 1 to 15, wherein the laser oscillates during the melting in step (d) and/or in step (f).

Embodiment 17: Method according to any of embodiments 1 to 16, wherein the melting in step (d) is carried out in such a way that the first selected region is at least partially melted again, and/or the melting in step (f) is carried out in such a way that the second selected region is at least partially melted again.

Embodiment 18: Method according to any of embodiments 1 to 17, wherein a power and/or a focus of the laser are varied during the melting in step (d) and/or in step (f).

Embodiment 19: Method according to any of embodiments 1 to 18, furthermore comprising applying or introducing at least one alloying element, especially in the form of a suspension, onto/into the applied powder layer in the first selected region and/or in the second selected region.

Embodiment 20: Method according to embodiment 19, wherein the alloying element is applied or introduced by means of a printhead.

Embodiment 21: Method according to embodiment 20, wherein the powder layer is applied by means of an application apparatus, in particular a doctor blade, to the build platform, with the application apparatus and the printhead being moved by a common actuator.

Embodiment 22: Method according to any of embodiments 1 to 21, wherein the melting in step (d) is carried out in such a way that the first selected region after a subsequent cooling has a first metallurgical structure, wherein the melting in step (f) is carried out in such a way that the second selected region after a subsequent cooling has a second metallurgical structure, and wherein the second metallurgical structure differs from the first metallurgical structure.

Embodiment 23: Apparatus for producing a component by means of an additive manufacturing method using a laser, comprising:

a process chamber having a build platform,

an application apparatus, in particular a doctor blade, for applying a powder layer of a metal powder to the build platform,

a process gas nozzle for introducing process gas into the process chamber,

at least one laser source for emitting a laser onto the powder layer and

a valve assembly for the selective supply of process gas to the process gas nozzle, wherein the valve assembly has at least a first valve path and a second valve path, wherein the valve assembly is connectible to a first process gas source and to a second process gas source, wherein the first valve path and the second valve path are actuable separately from one another in such a way that a first process gas from the first process gas source and/or a second process gas from the second process gas source are selectively introducible into the process chamber by means of the process gas nozzle.

Embodiment 24: Apparatus according to embodiment 23, furthermore comprising a control apparatus for automatically controlling the valve assembly on the basis of numerical data which define the geometric form of the component to be produced.

Embodiment 25: Apparatus according to embodiment 23 or 24, furthermore comprising a printhead for applying or introducing an alloying element, especially in the form of a suspension, onto or into the powder layer on the build platform.

Embodiment 26: Apparatus according to embodiment 25, furthermore comprising an actuator, the actuator being designed for jointly moving the application apparatus and the printhead.

Embodiment 27: Use of an apparatus according to any of embodiments 23 to 26 for carrying out a method according to any of embodiments 1 to 22.

Embodiment 28: Method for producing a component by means of an additive manufacturing method using a laser, the method comprising the following steps:

(a) providing a metal powder,

(b) applying a powder layer of the metal powder to a build platform of a process chamber,

(c) applying or introducing at least one alloying element, especially in the form of a suspension, onto or into the applied powder layer in at least one selected region, and

(d) melting the applied powder layer by means of a laser.

Embodiment 29: Method according to embodiment 28, wherein the alloying element is applied or introduced by means of a printhead.

Embodiment 30: Method according to embodiment 29, wherein the powder layer is applied by means of an application apparatus, in particular a doctor blade, to the build platform, with the application apparatus and the printhead being moved by a common actuator.

Embodiment 31: Method according to any of embodiments 28 to 30, furthermore comprising:

introducing a first process gas into the process chamber,

melting a first selected region of the applied powder layer by means of a laser in a first atmosphere which includes the first process gas,

introducing a second process gas into the process chamber, wherein the second process gas differs from the first process gas at least in terms of its composition and/or its pressure, and

melting a second selected region of the applied powder layer by means of the laser in a second atmosphere which includes the second process gas, wherein the second selected region differs from the first selected region.

Embodiment 32: Method according to embodiment 31, furthermore comprising melting in such a way that the first selected region and/or the second selected region during subsequent cooling become permanently bonded.

Embodiment 33: Method according to any of embodiments 28 to 32, wherein the metal powder is a metal alloy, in particular aluminium alloy.

Embodiment 34: Method according to any of embodiments 28 to 33, wherein the metal powder is composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti.

Embodiment 35: Method according to any of embodiments 31 to 34, wherein the first process gas and/or the second process gas include(s) at least one gas selected from the group consisting of: argon, helium, nitrogen, carbon monoxide, carbon dioxide, methane, propane, hydrogen and oxygen.

Embodiment 36: Method according to any of embodiments 31 to 35, wherein the first process gas and the second process gas include hydrogen, wherein the concentration of hydrogen in the first process gas is higher than the concentration of hydrogen in the second process gas.

Embodiment 37: Method according to any of embodiments 28 to 36, wherein during the melting a pressure in the process chamber is varied.

Embodiment 38: Method according to any of embodiments 28 to 37, furthermore comprising at least partially heat treating the applied layer during the melting.

Embodiment 39: Method according to any of embodiments 28 to 38, furthermore comprising at least partially heat treating the applied layer after the melting.

Embodiment 40: Method according to embodiment 38 or 39, wherein the heat treatment comprises melting, sintering, annealing, diffusion treatment or hydrogen-reducing treatment.

Embodiment 41: Method according to any of embodiments 38 to 40, wherein the heat treatment is effected by means of a defocused laser.

Embodiment 42: Method according to any of embodiments 31 to 41, wherein the first process gas and/or the second process gas are introduced into the process chamber in such a way that a laminar gas flow above the applied powder layer is generated.

Embodiment 43: Method according to embodiment 42, furthermore comprising arranging a glass plate at a predetermined distance from the applied powder layer, the predetermined distance being in a range from 0.5 mm to 20.0 cm and preferably from 1.0 cm to 10.0 cm.

Embodiment 44: Method according to any of embodiments 28 to 43, wherein the laser oscillates during the thermal treatment.

Embodiment 45: Method according to any of embodiments 28 to 44, wherein the melting is carried out in such a way that the selected region is at least partially melted again.

Embodiment 46: Method according to any of embodiments 28 to 45, wherein a power and/or a focus of the laser are varied during the melting.

Embodiment 47: Apparatus for producing a component by means of an additive manufacturing method using a laser, the apparatus comprising:

a process chamber having a build platform,

an application apparatus, in particular a doctor blade, for applying a powder layer of a metal powder to the build platform,

a printhead for applying or introducing an alloying element, especially in the form of a suspension, onto or into the powder layer on the build platform, and

at least one laser source for emitting a laser onto the powder layer.

Embodiment 48: Apparatus according to embodiment 47, furthermore comprising an actuator, the actuator being designed for jointly moving the application apparatus and the printhead.

Embodiment 49: Apparatus according to either of embodiments 47 and 48, furthermore comprising a process gas nozzle for introducing process gas into the process chamber.

Embodiment 50: Apparatus according to embodiment 49, furthermore comprising a valve assembly for the selective supply of process gas to the process gas nozzle, wherein the valve assembly has at least a first valve path and a second valve path, wherein the valve assembly is connectible to a first process gas source and to a second process gas source, wherein the first valve path and the second valve path are actuable separately from one another in such a way that a first process gas from the first process gas source and/or a second process gas from the second process gas source are selectively introducible into the process chamber by means of the process gas nozzle.

Embodiment 51: Apparatus according to embodiment 50, furthermore comprising a control apparatus for automatically controlling the valve assembly on the basis of numerical data which define the geometric form of the component to be produced.

Embodiment 52: Method according to any of embodiments 1 to 21 or 28 to 46, furthermore comprising changing between the first process gas and the second process gas by moving a sealing slide within the process chamber relative and in particular parallel to the build platform.

Embodiment 53: Apparatus according to any of embodiments 22 to 27 or 47 to 51, furthermore comprising a sealing slide, wherein the sealing slide is movable within the process chamber relative and in particular parallel to the build platform.

Embodiment 54: Apparatus according to any embodiment 53, wherein the sealing slide is connected to the application apparatus, wherein the application apparatus is movable relative to the build platform.

### BRIEF DESCRIPTION OF THE DRAWINGS

Further optional details and features of the invention are apparent from the following description of preferred examples shown diagrammatically in the figures.

In the figures:

FIGS. 1A to 1D show an apparatus for producing a component by means of an additive manufacturing method using a laser in various steps of a method for producing the component,

FIG. 2 shows a Schaeffler diagram for chromium-nickel steels,

FIGS. 3A and 3B each show an enlarged section of a component having different microstructures,

FIG. 4 shows a further apparatus for producing a component by means of an additive manufacturing method using a laser,

FIG. 5 shows a side view of a further apparatus for producing a component by means of an additive manufacturing method using a laser,

FIG. 6 shows a top view of the apparatus of FIG. 5, and

FIGS. 7A to 7C show top views of a further apparatus for producing a component by means of an additive manufacturing method using a laser in various operating states.

### EMBODIMENTS OF THE INVENTION

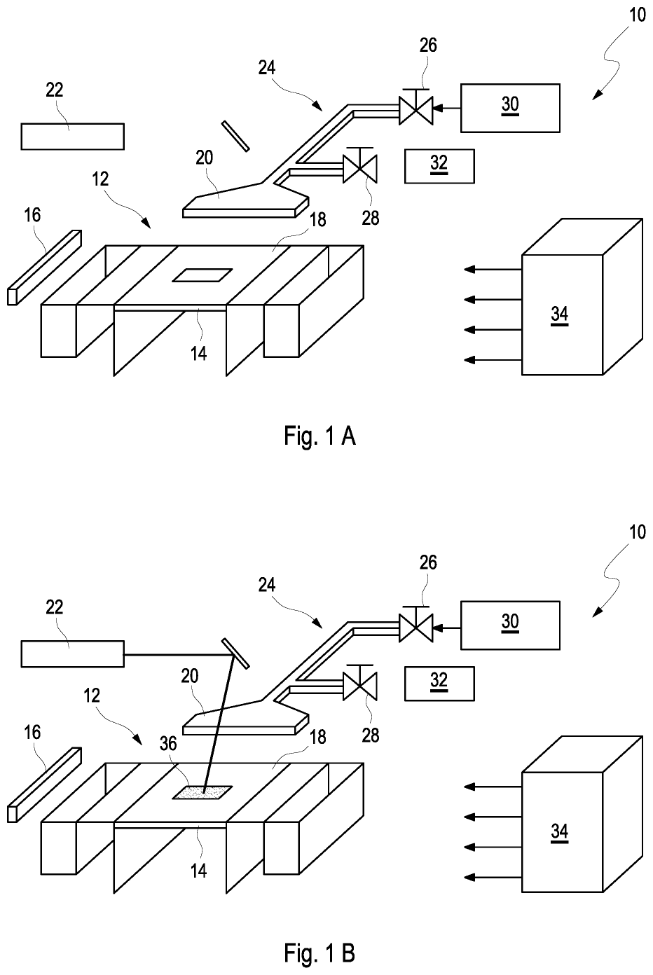

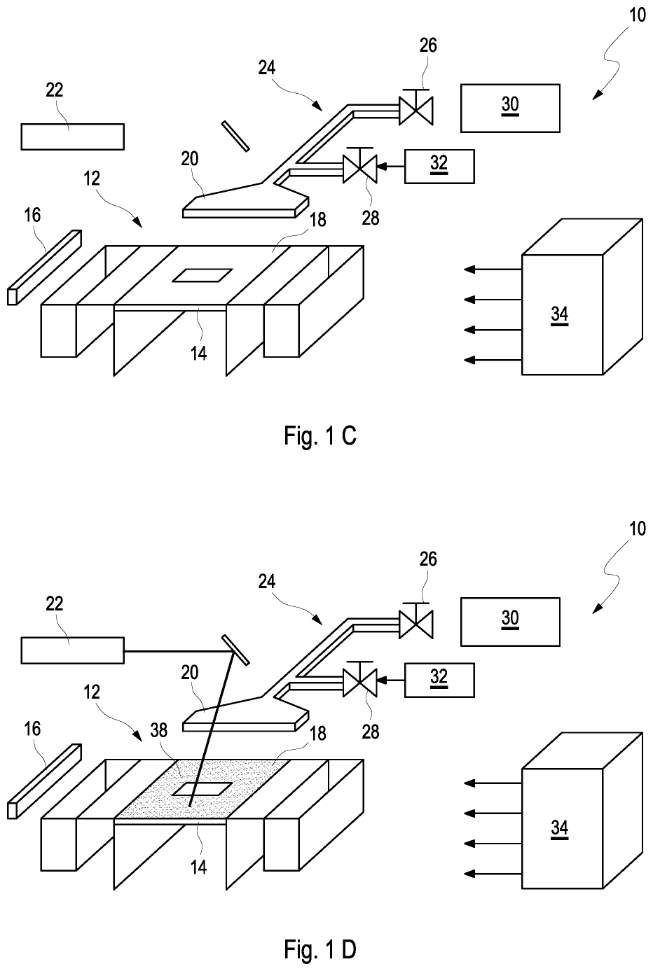

FIGS. 1A to 1D show an apparatus 10 for producing a component by means of an additive manufacturing method using a laser in various steps of a method for producing the component. The apparatus 10 has a process chamber 12 having a build platform 14, an application apparatus 16 for applying a powder layer 18 of a metal powder to the build platform 14, a process gas nozzle 20 for introducing process gas into the process chamber 12, at least one laser source 22 for emitting a laser onto the powder layer 18 and a valve assembly 24 for the selective supply of process gas to the process gas nozzle 20. The valve assembly 24 has at least a first valve path 26 and a second valve path 28. The valve assembly 24 is connectible to a first process gas source 30 and to a second process gas source 32. The first valve path 26 and the second valve path 28 are actuable separately from one another in such a way that a first process gas from the first process gas source 30 and/or a second process gas from the second process gas source 32 are selectively introducible into the process chamber by means of the process gas nozzle 20. The application apparatus 16 in the embodiment shown is a doctor blade. The apparatus 10 furthermore has a control apparatus 34. The control apparatus 34 is designed for automatically controlling the valve assembly 24. The actuation is effected in this case on the basis of numerical data which define the geometric form of the component to be produced. Accordingly, the control apparatus 34 enables a supply of the first process gas from the first process gas source 30 into the process chamber 12 via the first valve path 26, a supply of the second process gas from the second process gas source 32 into the process chamber 12 via the second valve path 28, or a supply of a mixture of the first process gas and the second process gas. It is explicitly emphasized that the valve assembly 24 may have further valve paths and can be connected to further process gas sources so that mixtures of three or more process gases are also suppliable into the process chamber 12. The first process gas and/or the second process gas include(s) at least one gas selected from the group consisting of: argon, helium, nitrogen, carbon monoxide, carbon dioxide, methane, propane, hydrogen and oxygen. For example, the first process gas and the second process gas include hydrogen, wherein the concentration of hydrogen in the first process gas is higher than the concentration of hydrogen in the second process gas.

In the embodiment shown, the control apparatus 34 is furthermore designed to control the laser source 22, the build platform 14 and the application apparatus 16.

The method for producing a component by means of an additive manufacturing method using a laser is described in detail hereafter on the basis of FIGS. 1A to 1D. First, the metal powder is provided. The metal powder can for example be provided in a powder store (not illustrated in more detail) of the apparatus 10. The metal powder is preferably a metal alloy. The metal powder can for example be composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti. Alternatively, the metal powder may be an aluminium alloy. A powder layer 18 of the metal powder is applied to the build platform 14 by means of the application apparatus 16. As shown in FIG. 1A, the first process gas is introduced into the process chamber 12. In particular, the process chamber 12 is flooded with the first process gas. For this purpose, the control apparatus 34 actuates the valve assembly 24 in such a way that the first valve path 26 is opened and the first process gas can flow out of the first process gas source 30 and into the process chamber 12.

As shown in FIG. 1B, a first selected region 36 of the applied powder layer 18 is subsequently melted by means of a laser, emitted by the laser source 22 onto the first selected region 36, in a first atmosphere which includes the first process gas. The first selected region is situated in the centre of the powder layer 18 merely by way of example. In this case, the control apparatus 34 controls the laser source 22 with respect to the position of the laser, the power of the laser, etc., on the basis of the geometric data for the component to be produced and of the desired microstructure in the first selected region 36. The melting is effected in particular in such a way that the first selected region 36 during subsequent cooling becomes permanently bonded. Since the powder layer 18 is arranged directly on the build platform 14, this permanent bond is formed with the build platform 14. The melting can be carried out in such a way that the first selected region after a subsequent cooling has a first metallurgical structure.

As shown in FIG. 1C, the second process gas is subsequently introduced into the process chamber 12. In particular, the process chamber 12 is flooded with the second process gas. For this purpose, the control apparatus 34 actuates the valve assembly 24 in such a way that the second valve path 28 is opened and the second process gas can flow out of the second process gas source 32 and into the process chamber 12. The second process gas differs from the first process gas at least in terms of its composition and/or its pressure.

As shown in FIG. 1D, a second selected region 38 of the applied powder layer 18 is subsequently melted by means of a laser, emitted by the laser source 22 onto the second selected region 38, in a second atmosphere which includes the second process gas. The second selected region 38 differs from the first selected region 36. For example, the second selected region 38 surrounds the first selected region 36. Here, the control apparatus 34 controls the laser source 22 with respect to the position of the laser, the power of the laser, etc., on the basis of the geometric data for the component to be produced and of the desired microstructure in the second selected region 38. The melting is effected in particular in such a way that the second selected region 38 during subsequent cooling becomes permanently bonded. Since the powder layer 18 is arranged directly on the build platform 14, this permanent bond is formed with the build platform 14. The melting can be carried out in such a way that the second selected region after a subsequent cooling has a second metallurgical structure, wherein the second metallurgical structure differs from the first metallurgical structure.

Subsequently, the control apparatus 34 lowers the build platform 14 by a predetermined distance which corresponds to the height of a further powder layer 18 to be subsequently applied. For this further powder layer 18, too, the first process gas is introduced and a first selected region of the further powder layer is melted, and/or the second process gas is introduced and a second selected region of the powder layer is melted. These steps can be repeated as required until the component has been completely produced layer-by-layer. In the process, each further molten layer or regions0 thereof, during subsequent cooling, forms a permanent bond with the layer located directly underneath.

Since the process gas used as protective gas has an influence on the phase transformation of a metal alloy, but does not interact significantly, if at all, with the metal powder or with the solidified component, the process gas is changed within a build job, preferably within a build plane, in order to achieve different properties in different regions of the build job or of the build plane. Expediently, scan vectors/regions to be selectively melted on a build plane having the same target property are collectively exposed by means of the laser, since a change of process gas takes longer than a change from one scan position to the next.

In addition to the use of discrete process gases, these can also be continuously mixed with varying composition. This allows, for example, graded materials to be produced. In particular, steels can be carburized using carbon-releasing process gases and the austenite proportion can be increased by nitrogen or nitrogen-containing atmosphere as opposed to purely inert process gases. A low proportion of oxygen in the process gas (a few percent) can reduce the proportion of carbon by means of oxidation. Using hydrogen-containing atmosphere, especially in the case of aluminium, can generate a porosity in the material in a controlled manner depending on the hydrogen content. This is based on the fact that the solubility of hydrogen in aluminium in the liquid state is markedly higher than in the solid state. On solidification, the no longer soluble hydrogen is expelled in the form of small pores. Depending on the original partial pressure of hydrogen in the process gas atmosphere, or dissolved in the aluminium melt, large or small pores, or even no pores, are formed.

The method can be modified as follows.

During the melting of the first selected region and/or of the second selected region, a pressure in the process chamber can be varied.

During the melting of the first selected region and/or of the second selected region, the applied layer can be at least partially heat treated. Alternatively or additionally, the method can furthermore comprise at least partially heat treating the applied layer after that of the first selected region and/or of the second selected region. For example, the heat treatment can be effected by means of a defocused laser. The first process gas and/or the second process gas can be introduced into the process chamber in such a way that a laminar gas flow above the applied powder layer is generated. Furthermore, a glass plate can be arranged at a predetermined distance from the applied powder layer, the predetermined distance being in a range from 0.5 mm to 20.0 cm and preferably from 1.0 cm to 10.0 cm. The laser can oscillate during the melting of the first selected region and/or of the second selected region. The melting of the first selected region and/or of the second selected region can be carried out in such a way that the first selected region and/or the second selected region are at least partially melted again. A power and/or a focus of the laser can be varied during the melting of the first selected region and/or of the second selected region.

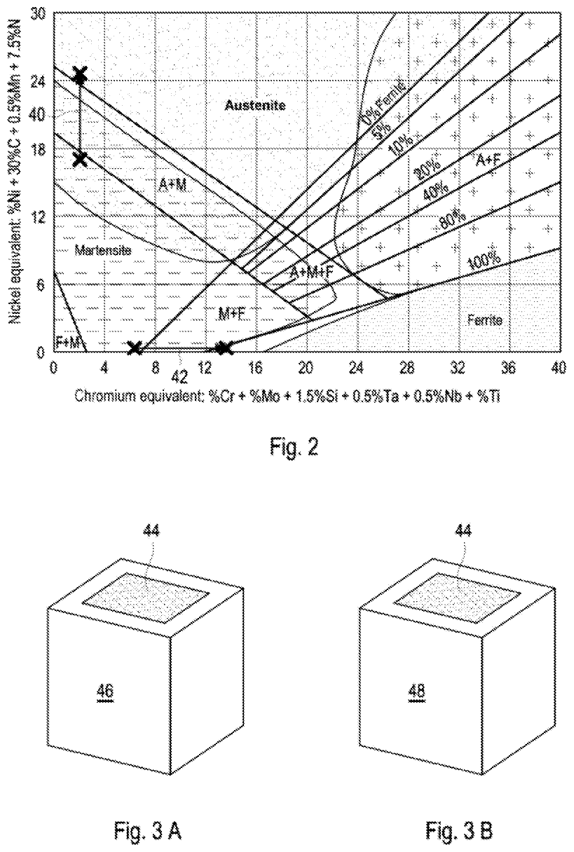

FIG. 2 shows a Schaeffler diagram for chromium-nickel steels. The chromium equivalents form the abscissa and the nickel equivalents form the ordinate of the diagram. By means of the diagram, points in the diagram can be depicted for steels and cast irons. The nickel equivalent is calculated from the proportions by mass of the alloying elements which in the case of iron result in austenite being present in the microstructure. The chromium equivalent represents the efficacy of the ferrite-forming elements. The Schaeffler diagram is divided into different regions that represent the microstructure present. A point can be plotted in the Schaeffler diagram for each material. Depending on the location of the point, inter alia conclusions can be drawn concerning the microstructure present. The regions of the microstructure are austenite (A), martensite (M), ferrite (F) and transition regions for these microstructures indicated by (F+M), (A+M), (M+F) (A+M+F) and (A+F).

The Schaeffler diagram shown in FIG. 2 illustrates for steel materials, i.e. chromium-nickel steels, the influence of various alloying elements on the microstructure formation under welding-typical cooling conditions. The Schaeffler diagram was originally developed to allow a choice of welding electrodes to be made for various materials to be welded. The Schaeffler diagram makes it possible to estimate the effects of various welding additives on the developing microstructure during welding. Various alloying elements having a similar influence on the austenite formation, such as for example Ni, C, N, Mn, and on the formation of a ferritic microstructure, such as for example Cr, Mo, Si, Ta, Nb, Ti, are combined in the Schaeffler diagram as nickel equivalent or chromium equivalent, respectively. For example, an increase in the nickel equivalent by 8% can suppress the development of martensite and promote the formation of room temperature-stable austenite, as can be seen by the arrow 40. An increase in the chromium equivalent by 6% can likewise prevent the development of martensite and in contrast bring about the formation of a ferritic microstructure, as can be seen by the arrow 42.

The strong influence of nitrogen on the nickel equivalent is evident in the Schaeffler diagram by the factor 7.5. Other diagrams known from the prior art, such as for example the DeLong diagram, even indicate a factor of 30 for the influence of nitrogen. This means that for the abovedescribed shift along the arrow 40 the nitrogen proportion in an alloy only needs to be increased by a proportion of less than 1%.

In order to be able to significantly modify the developing microstructure of an alloy by a minor change in nickel or chromium equivalent, it is necessary for the alloy composition of the starting powder to be close to a boundary region in the Schaeffler diagram. This is illustrated by the plotted alloys along the arrows 40 and 42 in the Schaeffler diagram. Various methods can be used in this case to achieve a particular alloy composition. Firstly, a base material having the desired alloy composition may be atomized directly. Secondly, pre-atomized powders of various alloys may be mixed or supplemented with particular elemental powders. Here, however, sufficient mixing of the powders should be ensured in order to achieve a uniform chemical composition within a build job.

FIGS. 3A and 3B each show an enlarged section of a component having different microstructures. FIG. 3A shows the component having a ferritic core 44 and an austenitic shell 46 or surface surrounding the core 44. FIG. 3B shows the component having a ferritic core 44 and a martensitic shell 48 or surface surrounding the core 44. FIGS. 3A and 3B show how various microstructure regions may be used to set particular component properties. For example, the ferritic core 44 of a component can serve for achieving a high strength especially in the event of static mechanical loading. If a resistance to the influence of media is required, this can be done by establishing an austenitic microstructure at the surface. As protection against abrasion or for the achievement of internal compressive stresses in the surface, a formation of the hardened microstructure martensite may be desirable. Internal compressive stresses represent a possibility for improving the fatigue strength for components under cyclical loading. In addition, a controlled adjustment of a DP steel (dual-phase steel) having a ferritic basic matrix and strength-increasing martensitic regions distributed in island-like fashion can achieve specific properties of the material.

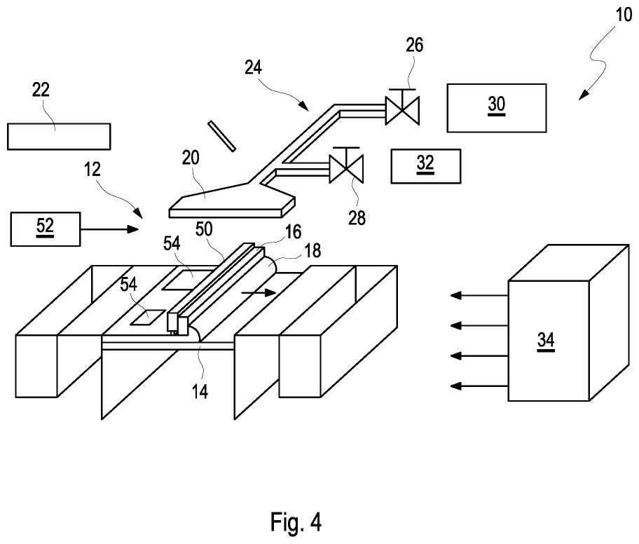

FIG. 4 shows a further apparatus 10 for producing a component by means of an additive manufacturing method using a laser. Hereinbelow, merely the differences from the apparatus shown in FIGS. 1A to 1D are described, and identical or comparable components are provided with identical reference numerals. The further apparatus 10 of FIG. 4 has a printhead 50 for applying or introducing an alloying element onto or into the powder layer 18 on the build platform. The alloying element can in particular be applied or introduced in the form of a suspension onto or into the powder layer 18. The further apparatus can furthermore comprise an actuator 52 which is designed for jointly moving the application apparatus 16 and the printhead 50.

With the apparatus 10 of FIG. 4, the method disclosed can be designed in such a way that a metal powder is provided, a powder layer 18 of the metal powder is applied to the build platform 14 and, in addition to the powder layer 18, at least one alloying element is applied or introduced, especially in the form of a suspension, onto or into the applied powder layer in at least one selected region 54. The applied powder layer 18 is subsequently melted by means of the laser. These steps can be repeated multiple times. It is explicitly emphasized that the apparatus shown in FIG. 4 can be realized separately from or in combination with the apparatus shown in FIGS. 1A to 1D. It is likewise explicitly emphasized that the method described in connection with FIGS. 1A to 1D, including modifications, can be carried out in combination with the method described in connection with FIG. 4 or separately therefrom.

The explanations hereinbelow apply equally both to the method described in connection with FIGS. 1A to 1D and to the method described in connection with FIG. 4.

By changing the process gas, the chemical composition of the material is modified in a spatially delimited manner in particular by the following proportions. An increase in the carbon proportion by up to 1.0%, in particular 0.2%, more particularly 0.08% and yet more particularly 0.03% can be realized via CO₂ or CO. To increase the carbon content, in particular process gases having a CO₂ proportion of from 100% down to 20% or in particular down to 5% and especially in the case of high alloy steels down to 2%, can be used in order to set the desired effect.

A reduction in the carbon content is possible by means of oxygen-containing process gases having an oxygen content of up to 15%, in particular an oxygen content of up to 5%, especially an oxygen content of 2%. The reduction in the carbon proportion here is in particular up to 70%, especially up to 30% of the initial content.

Nitrogen oxides NOx may also be used as process gases. This can simultaneously increase the nitrogen content and reduce the carbon content. This is of interest in particular when the intention is to influence the hardenability and the maximum achievable hardness.

An increase in the nitrogen content can be effected both by nitrogen of technical grade purity and by mixtures of nitrogen with inert gases, such as for example helium, argon, or other active gases, such as for example CO₂, CO. The nitrogen proportion here may optionally be up to 100%, preferably up to 20% and in particular up to 2%.

The nitrogen proportion in the material in the process changes preferably by up to 0.6%, in particular up to 0.2%, especially in particular up to 0.05% and by a minimum of 0.01%, in particular

by a minimum of 0.03% and especially 0.08%.

Not all alloying elements are expediently convertible into a gaseous state or usable as such in the process. In order to modify the chemical composition by means of such elements, alloying elements can also be used in the solid state as described above. For improved meterability of the alloying elements in the printhead, these can in particular be printed in the form of a suspension. The materials used here are in particular chromium, silicon, molybdenum and titanium and possibly carbon, for example in the form of graphite. Chemical compounds with these elements, such as for example oxides, carbides or nitrides, are optionally also applicable, possibly also as a solution.

The powders which are applied with a printhead, especially in the form of a suspension, have a particle size which is far below the size of the material particles applied with the doctor blade, which have a size of approx. 10-100 μm. The size of the particles applied by the printhead is in particular of the magnitude of below 10 μm, in particular below 3 μm and more particularly below 1 μm.

The proportions of the mentioned alloying elements that are applied with the printhead are, proportional to the mass of the materials applied by the doctor blade, only up to at most 20%, in particular at most 7% and more particularly up to at most 2%.

Starting materials based on iron are in particular composed correspondingly:

At least 55%, in particular at least 75%, at most 99%, in particular at most 80% iron.

Preferably at least 1%, in particular at least 10% and at most 24% nickel.

Preferably at least 1% chromium, in particular at least 8% chromium and at most 35% chromium.

Additional alloying elements are typically: carbon, molybdenum, manganese, copper, tungsten, vanadium, silicon, tantalum, niobium and titanium.

The elements nitrogen and optionally carbon can on the one hand be greatly reduced in the starting material in order to achieve a large modification of the microstructure properties by addition of these elements in the SLM process (SLM—selective laser melting). The nitrogen proportion and the carbon proportion can be limited to 0.1%, in particular 0.04%, more particularly to up to 0.01%. On the other hand, already relatively high nitrogen and carbon contents of for example 0.2% in the starting material may be used and these then reduced locally in the process.

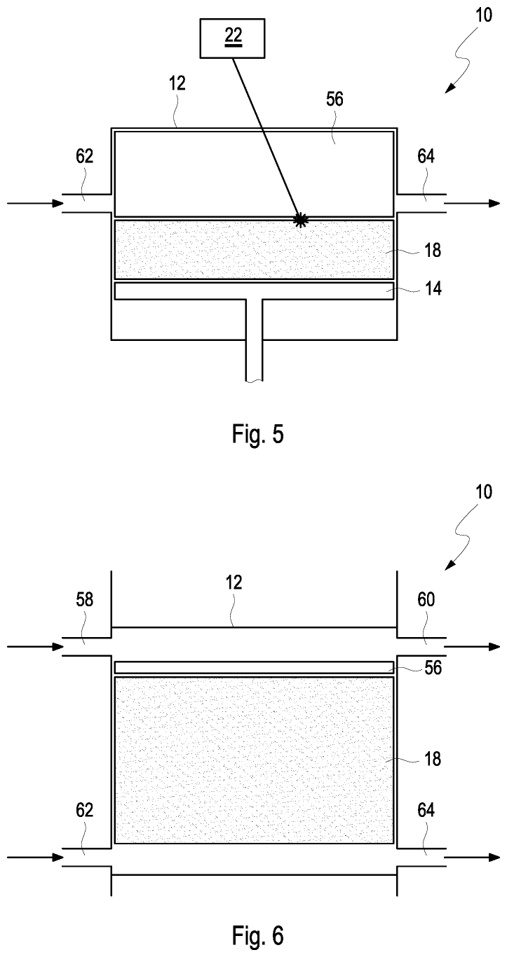

FIG. 5 shows a side view of a further apparatus 10 for producing a component by means of an additive manufacturing method using a laser. FIG. 6 shows a top view of the apparatus 10 of FIG. 5. Hereinbelow, merely the differences from the apparatus shown in FIGS. 1A to 1D are described, and identical or comparable components are provided with identical reference numerals. The apparatus 10 of FIGS. 5 and 6 has a sealing slide 56. The sealing slide 56 is arranged within the process chamber 12. The sealing slide 56 is arranged above the build platform 14. The sealing slide 56 serves as a lateral delimitation and therefore laterally contacts the walls of the process chamber 12. The sealing slide 56 is movable relative to the build platform 14. Thus the sealing slide 56 is movable in particular parallel to the build platform 14. In addition, a first connection or inlet 58 of the first process gas source 30 into the process chamber 12 and a first outlet 60 for the first process gas out of the process chamber 12 are illustrated. In addition, a second connection or inlet 62 of the second process gas source 32 into the process chamber 12 and a second outlet 64 for the second process gas out of the process chamber 12 are illustrated. The first inlet 58 and the first outlet 60 lie opposite each other. The second inlet 62 and the second outlet 64 lie opposite each other. The first inlet 58 and the first outlet 60 and the second inlet 62 and the second outlet 64 are situated on different sides of the sealing slide 56. In other words, the sealing slide 56 is arranged in the manner of a sandwich between the first inlet 58 and the first outlet 60 on one side and the second inlet 62 and the second outlet 64 on the other. During operation of the apparatus 10, the laser of the laser source 22 penetrates from above through a laser protection glass (not shown in more detail) into the process chamber 12 in order to expose the uppermost powder layer 18 on the build platform 14. The movable sealing slide 56 seals against the laser protection glass and the powder layer 18. A change between the first process gas and the second process gas is effected by moving the sealing slide 56, which when moved permits admission of one process gas and displacement of the process gas to the corresponding outlet of the other process gas. In the case of the exemplary position of the sealing slide 56 in FIG. 6, the process chamber 12 is completely flooded with the second process gas, while the sealing slide 56 displaces the first process gas towards the outlet 60. The sealing slide 56 in the process ensures separation of the process gases.

The aim of the apparatus 10 is to realize differing material and alloying states in a layer plane. To this end, gas changes are required not only once, but multiple times, for example more than 100 gas changes, over the entire process duration. One problem with this is that a large gas volume in the system always has to be exchanged. On account of the large gas volume, the system is sluggish and a change takes a very long time, for example a few minutes. Since the gas change takes place by way of a displacement with the new process gas, this is accompanied by high gas consumption and high costs. The apparatus of FIGS. 5 and 6 offers a solution by means of the use of at least two gas chambers each optionally having a dedicated recirculation and treatment unit (gas filter). The sealing surfaces are the glass plate or laser protection glass and also a lower and lateral sealing delimitation which can be displaced over the powder bed. This sealing delimitation is realized by the movable sealing slide 56. With this, the surface of the powder bed can be exposed to different gases without these mixing and having to be exchanged in a laborious manner in the overall recirculation system.

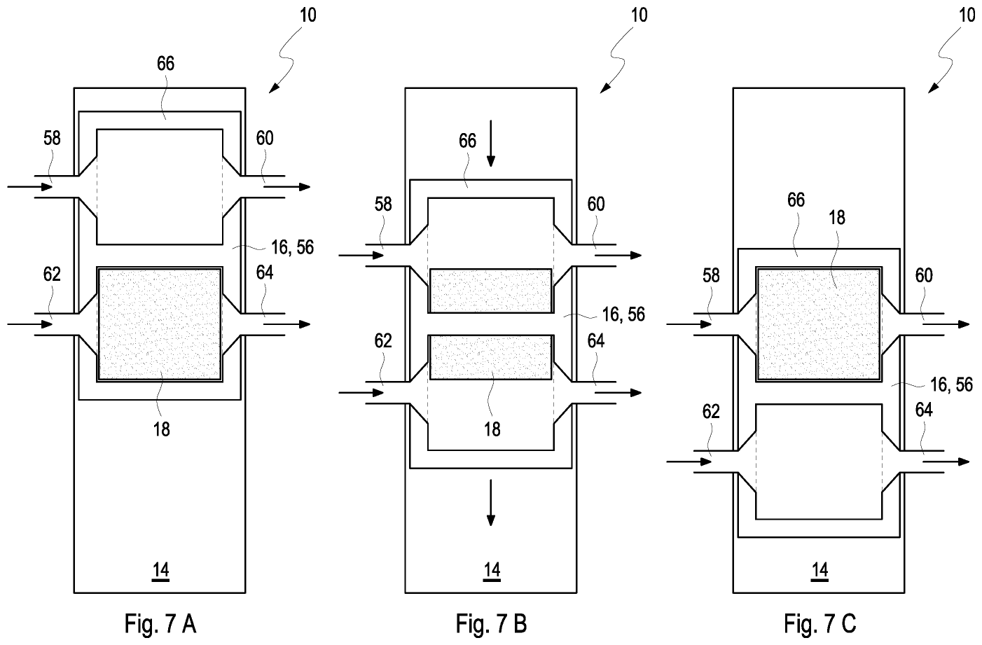

FIGS. 7A to 7C show top views of a further apparatus 10 for producing a component by means of an additive manufacturing method using a laser in various operating states. Hereinbelow, merely the differences from the apparatus shown in FIGS. 5 and 6 are described, and identical or comparable components are provided with identical reference numerals. In the apparatus 10 shown in FIGS. 7A to 7C, the sealing slide 56 is connected to the application apparatus 16 by means of a frame 66. The application apparatus 16 is movable relative to the build platform 14. Thus the application apparatus 16 is movable in particular parallel to the build platform 14. Accordingly, the sealing slide 56 is movable integrally/together with the application apparatus 16 relative to the build platform 14. Thus the sealing slide 56 is movable in particular parallel to the build platform 14. The application apparatus 16 is for example a movable doctor blade. In the apparatus 10 shown in FIGS. 7A to 7C, during operation the entire frame 66 is displaced along with the doctor blade movement or the movement of the application apparatus 16, so that the supply of gas can always be effected centrally through a nozzle. The connections or inlets 58, 62 for the first process gas and the second process gas and any further process gases are designed to be flexible so that they can follow the movement of the frame 66. The sealing slide 56 and the doctor blade or application apparatus 16 for applying the powder to the build platform 14 are situated in the centre. FIGS. 7A to 7C show the two positions/locations of the frame 66 with sealing slide 56 for the sole use of the first and second process gas and also an intermediate position during the movement of the frame 66 or application apparatus 16 or during the gas change. In the exemplary position of the frame 66 or sealing slide 56 in FIG. 7A, the process chamber 12 is completely flooded with the second process gas, while the sealing slide 56 displaces the first process gas towards the first outlet 60. In the exemplary position of the frame 66 or sealing slide 56 in FIG. 7B, the process chamber 12 is the sealing slide 56 is situated approximately in the centre of the build platform or of the powder layer 18 located thereupon, so that the process chamber 12 is flooded with the first process gas on one side of the sealing slide 56 and is flooded with the second process gas on the other side of the sealing slide 56. In the exemplary position of the frame 66 or sealing slide 56 in FIG. 7C, the process chamber 12 is completely flooded with the first process gas, while the sealing slide 56 displaces the second process gas towards the second outlet 64. The sealing slide 56 thus ensures separation of the process gases.

1. Method for producing a component by means of an additive manufacturing method using a laser, the method comprising the following steps:
(a) providing a metal powder,
(b) applying a powder layer of the metal powder to a build platform of a process chamber,
(c) introducing a first process gas into the process chamber,
(d) melting a first selected region of the applied powder layer by means of a laser in a first atmosphere which includes the first process gas,
(e) introducing a second process gas into the process chamber, wherein the second process gas differs from the first process gas at least in terms of its composition and/or its pressure, and
(f) melting a second selected region of the applied powder layer by means of the laser in a second atmosphere which includes the second process gas, wherein the second selected region differs from the first selected region.

2. Method according to claim 1, furthermore comprising repeating, in particular repeating multiple times, at least steps (a) to (d) and/or repeating, in particular repeating multiple times, steps (e) and (f).

3. Method according to claim 1, wherein the metal powder is a metal alloy, in particular aluminium alloy, or the metal powder is composed of at least 55% Fe, in particular at least 75% Fe and at most 99% Fe, in particular at most 80% Fe, preferably at least 1% Ni, in particular at least 10% Ni and at most 24% Ni, preferably at least 1% Cr, in particular at least 8% Cr and at most 35% Cr, and also at least one additional alloying element selected from the group consisting of C, Mo, Mn, Cu, W, V, Si, Ta, Nb and Ti.

4. Method according to claim 1, wherein the first process gas and/or the second process gas include(s) at least one gas selected from the group consisting of: argon, helium, nitrogen, carbon monoxide, carbon dioxide, methane, propane, hydrogen and oxygen.

5. Method according to claim 1, wherein the first process gas and the second process gas include hydrogen, wherein the concentration of hydrogen in the first process gas is higher than the concentration of hydrogen in the second process gas.

6. Method according to claim 1, wherein during the melting in step (d) and/or in step (f) a pressure in the process chamber is varied.

7. Method according to claim 1, furthermore comprising at least partially heat treating the applied layer during the melting in step (d) and/or in step (f) and/or at least partially heat treating the applied layer after the melting in step (d) and/or in step (f), wherein the heat treatment comprises melting, sintering, annealing, stress relief annealing, diffusion annealing or low hydrogen annealing, with the heat treatment preferably being effected by means of a defocused laser.

8. Method according to claim 1, furthermore comprising arranging a glass plate at a predetermined distance from the applied powder layer, the predetermined distance being in a range from 0.5 mm to 20.0 cm and preferably from 1.0 cm to 10.0 cm, wherein the first process gas and/or the second process gas are introduced into the process chamber in such a way that a laminar gas flow above the applied powder layer is generated.

9. Method according to claim 1, wherein the laser oscillates during the melting in step (d) and/or in step (f), and/or a power and/or a focus of the laser are varied during the melting in step (d) and/or in step (f).

10. Method according to claim 1, wherein the melting in step (d) is carried out in such a way that the first selected region is at least partially melted again, and/or the melting in step (f) is carried out in such a way that the second selected region is at least partially melted again.

11. Method according to claim 1, furthermore comprising applying or introducing at least one alloying element, especially in the form of a suspension, onto/into the applied powder layer in the first selected region and/or in the second selected region.

12. Method according to claim 11, wherein the alloying element is applied or introduced by means of a printhead.

13. Method according to claim 1, wherein the melting in step (d) is carried out in such a way that the first selected region after a subsequent cooling has a first metallurgical structure, wherein the melting in step (f) is carried out in such a way that the second selected region after a subsequent cooling has a second metallurgical structure, and wherein the second metallurgical structure differs from the first metallurgical structure.

14. Method according to claim 1, furthermore comprising changing between the first process gas and the second process gas by moving a sealing slide (56) within the process chamber relative and in particular parallel to the build platform.

15. Apparatus for producing a component by means of an additive manufacturing method using a laser, comprising:
a process chamber having a build platform,
an application apparatus, in particular a doctor blade, for applying a powder layer of a metal powder to the build platform,
a process gas nozzle for introducing process gas into the process chamber,
at least one laser source for emitting a laser onto the powder layer and a valve assembly for the selective supply of process gas to the process gas nozzle,
wherein the valve assembly has at least a first valve path and a second valve path,
wherein the valve assembly is connectible to a first process gas source and to a second process gas source, wherein the first valve path and the second valve path are actuable separately from one another in such a way that a first process gas from the first process gas source and/or a second process gas from the second process gas source are selectively introducible into the process chamber by means of the process gas nozzle.

16. Apparatus according to claim 15, furthermore comprising a control apparatus for automatically controlling the valve assembly on the basis of numerical data which define the geometric form of the component to be produced.

17. Apparatus according to claim 15, furthermore comprising a sealing slide, wherein the sealing slide is movable within the process chamber relative and preferably parallel to the build platform.

18. Apparatus according to claim 17, wherein the sealing slide is connected to the application apparatus, wherein the application apparatus is movable relative to the build platform.
